(19) United States
(12) Patent Application Publication
(10) Pub. No.: US 2013/0041844 A1
(43) Pub. Date: Feb. 14, 2013

(54) METHODS AND SYSTEMS FOR PROVIDING INVESTMENT OPPORTUNITIES

(71) Applicants: Christopher H. Cole, Phoenix, AZ (US); Marc T. Nemer, Phoenix, AZ (US); Jeffrey C. Holland, Paradise Valley, AZ (US); Chong P. Huan, Phoenix, AZ (US); Todd K. Lockwood, Phoenix, AZ (US)

(72) Inventors: Christopher H. Cole, Phoenix, AZ (US); Marc T. Nemer, Phoenix, AZ (US); Jeffrey C. Holland, Paradise Valley, AZ (US); Chong P. Huan, Phoenix, AZ (US); Todd K. Lockwood, Phoenix, AZ (US)

(73) Assignee: Cole Capital Advisors

(21) Appl. No.: 13/446,342

(22) Filed: Apr. 13, 2012

Related U.S. Application Data
(60) Provisional application No. 61/474,871, filed on Apr. 13, 2011.
(60) Provisional application No. 61/589,993, filed on Jan. 24, 2012.

(51) Int. Cl. G06Q 40/06

(52) U.S. Cl. 705/36 R

(57) ABSTRACT

Processes and supporting systems facilitate the periodic assessment of the value of illiquid assets held by a real estate investment trust (“REIT). These values are combined with valuations of the liquid assets (securities, cash) held by the fund and used to calculate an overall net asset value. The periodic assessments may be adjusted intra-period to account for extraordinary events. In order to manage redemptions, the liquidity of the fund is managed and monitored and as redemption requests are received a “market condition” is established. Based on the market condition, a redemption cap is applied, which may limit the amount that may redeemed during any one period.

### CROSS-REFERENCE TO RELATED APPLICATIONS

This application claims priority to, and the benefit of, U.S. provisional patent application Ser. No. 61/474,871, filed on Apr. 13, 2011, and U.S. provisional patent application Ser. No. 61/589,993, filed on Jan. 24, 2012, both entitled “METHODS AND SYSTEMS FOR PROVIDING INVESTMENT OPPORTUNITIES.”

### FIELD OF THE INVENTION

This invention relates generally to techniques and supporting systems for providing investment opportunities, and more specifically to investments related to real estate investment trusts.

### BACKGROUND

Over the past 15 years, the structure of compensation paid to individuals providing personalized investing advice to retail investors has been shifting from a commission-based and transaction-oriented model to a framework based on a fixed fee percentage based on assets under management (“fee-based model”). Under a fee-based model, the investment advisor (sometimes referred to as the “advisor”) receives no commission income on the purchase or sale of securities for an investor's account; rather, the advisor is compensated based on a specific percentage of AUM (assets under the management of the advisor) that are attributable to an investor. Incentives to sell particular products or to generate trading transactions are in large measure eliminated under a fee-based model. According to research by Cogent (2010), 54% of advisors' aggregate compensation in 2010 was expected to come from asset-based fees, and by 2012 that figure is projected to increase to 63%.

The transition of the retail financial services industry to a fee-based model has proven beneficial for both clients and advisors. A fee-based model allows the advisor to provide holistic portfolio management and customized advice to help the individual investor meet his/her overall financial objectives. Advisors generally take a “top down” approach to analyzing a client's goals and constraints in order to construct the most suitable asset allocation strategy for that client.

The goal of any asset allocation strategy is to obtain the highest return for a given level of expected risk, where risk is generally measured by portfolio volatility. One of the most effective means by which volatility can be tempered is with a diversified portfolio of investments that includes non-correlated asset classes. Correlation is a statistical measure which indicates the degree to which the prices of asset classes move with one another. The possible correlation values range from −1.0 to 1.0; a value of 1 is a perfect correlation, and a value of −1 is a negative correlation. (For example, corporate bonds had a 0.3 correlation to large cap stocks.) Commercial real estate has a very low correlation with other asset classes that may be included in an investor's portfolio, such as large, mid, small cap and international stocks, or short, medium and long-term government or corporate bonds (“other asset classes”). Currently, for most retail investors, an allocation to commercial real estate in a fee-based account—if any—is through investment in shares of a real estate investment trust (“REIT”) that is listed on a securities exchange such as the New York Stock Exchange (“listed REIT”), can be purchased without a product-based commission, and has a value that fluctuates with the market on which it is traded, as well as market perceptions on the buy and sell side about the inherent value of the shares.

Listed REITs generally fluctuate in price with the stock market as a whole; that is, there is a relatively close relationship or correlation between changes in the price of listed REITs and changes in value of the stock market. For example, according to data provided by Morningstar, Inc., for the period from 1985 to 2009, on average approximately 60% of the change in share price of listed REITs was the same as, or in direct alignment with, the average change in value of the Standard & Poor's 500 Index (“S&P 500”), a commonly used index to reflect the equity stock market as a whole. This close correlation suggests that the value of shares of listed REITs reflects a variety of factors beyond the value of the underlying real estate investments. As a result, listed REITs are an imperfect proxy for an investment in commercial real estate and an imperfect means of tempering portfolio volatility through investment in an asset class that is not correlated with other asset classes.

Morningstar data shows that, on average, approximately 20% of the change in price of a direct investment in commercial real estate, as measured by actual transactions, was the same as, or in direct alignment with, the average change in value of the S&P 500. Shares of listed REITs, on average, were three times more likely than a direct investment in real estate to reflect a change in price in accordance with, or at the same time as, a change in value of the S&P 500. This demonstrates that direct investments in commercial real estate are significantly less correlated to the stock market, for example, than are listed REITs, and are more effective in reducing portfolio volatility than listed REITs.

In contrast to listed REITs, REITs whose shares are not traded on a securities exchange or other securities market (“non-traded REITs” or “NTRs”) offer lower volatility than listed REITs and relatively low correlation to most equity and fixed income classes, including listed REITs. However, there are inherent drawbacks in the NTR structure that currently make NTRs impractical to use in a fee-based account. For example, NTRs are not listed for trading on a stock exchange or other securities market. This limits the liquidity of an NTR investment, and precludes use of the NTR by an advisor for allocation of any investor account assets that the advisor may seek to reallocate to other asset classes at a future point in time. Another drawback is that NTRs have a finite life with a specified date by which it is anticipated there will be some type of liquidity event, such as listing on a national exchange or liquidation within 10 years of the end of the offering period. This limits the “longevity” of an NTR investment, and precludes use of the NTR by an advisor for allocation of any investor account assets that the advisor may NOT wish to reallocate to other asset classes at a future point in time. NTRs also sell shares at a fixed price throughout the offering period, and currently value their common stock no less frequently than each eighteen months thereafter. These features limit the “transparency” and responsiveness of an NTR investment's value, and preclude use of the NTR by an advisor for allocation of any investor account assets for which the advisor, or the investor, seek verifiable and continuously adjusted valuations. Moreover, NTRs typically limit redemptions to 5% or less of the weighted average number of shares outstanding during the trailing twelve month period. This further limits the liquidity of an NTR investment, and precludes use of the NTR by an advisor for allocation of any investor account assets that the advisor may seek to reallocate to other asset classes at a future point in time.

In short, because NTRs lack daily liquidity and daily share pricing, advisors and investors are unable to use NTRs for continuously readjusted investment portfolio allocations, and are unable to use NTRs for continuously monitored and evaluated components of an investment portfolio asset allocation strategy.

What is needed, therefore, is an alternative to a listed REIT or NTR, each of which has inherent drawbacks—that is, an investment vehicle (“fund”) providing access to and investment in commercial real estate, that is open-ended with an indefinite life (no termination event), offers daily pricing of its shares at that day's net asset value per share (“NAV”) calculated on a transparent basis, and permits investors to purchase and redeem shares at that day's NAV without limitations.

### SUMMARY OF THE INVENTION

Embodiments of the invention provide investment products as well as techniques and supporting systems for offering and managing the products. More specifically, investors, as well as advisors on behalf of their clients, may allocate capital to commercial real estate investments through a daily valued REIT that offers daily purchases and daily redemptions but that is not actively traded on any open market. The investors benefit from the greater diversification and reduced volatility by virtue of adding such an investment in their portfolios, and the relative illiquidity of real estate offerings is substantially diminished because the structure is designed to provide greater liquidity through daily valuations, purchases and redemptions. The relative lack of transparency in valuation of commercial real estate products is substantially eliminated through the detailed valuation methodology and the use of an independent valuation expert in connection with “rolling” valuations of real estate and real estate-related assets and liabilities of the fund. This structure accommodates use by individual investors as well as investment advisors in ongoing portfolio allocation strategies, rather than for one-time acquisition. Typical ongoing usage events include portfolio rebalancing, systematic investments, and systematic withdrawals.

In order to manage the daily pricing and redemption requirements of the investment, the processes and systems described below have been developed to facilitate the periodic assessment of the value of illiquid assets held by the REIT. These values are combined with valuations of the liquid assets (securities, cash) held by the fund along with daily expense accruals and used to calculate an overall net asset value. The periodic assessments may be adjusted intra-period to account for unforeseen events such as natural disasters and political or economic events. In order to manage redemptions, the liquidity of the fund is managed and monitored and as redemptions are received a “market condition” is established. Based on the market condition, a redemption cap may be purely discretionary, or, in some cases, calculated (either using a fixed value or a formula, subjective elements, or a combination of each). In each case, the cap is applied as a limit (in dollars, shares or both) to the amount an individual may redeem during any one period. The cap may also be implemented across the entire fund, if necessary.

Therefore, in a first aspect, a system for pricing shares of an open-ended, unlisted real estate investment trust includes a processor for executing computer-executable instructions and a memory for storing the computer-executable instructions. Executing the instructions results in the implementation of an appraisal module that facilitates the determination of real estate pricing data based on a periodic appraisal of illiquid real estate assets held in the real estate investment trust and a pricing module that combines the real estate pricing data with pricing data related to liquid securities held by the real estate investment trust and accrued expenses, resulting in a net asset value of the fund.

In some embodiments, the appraisal module further facilitates the application of an adjustment to the real estate pricing data between periodic appraisals, which, when combined with the real estate appraisal data and the pricing data related to liquid securities results in an adjusted net asset value of the fund. The pricing module may use the adjusted net asset value of the fund and the number of outstanding shares to calculate a per share net asset value of the unlisted real estate investment trust. In some instances, the system also includes a data storage module for storing the real estate appraisal data and pricing data related to liquid securities.

The system may, in some instances, further include a redemption module that receives redemption orders from owners of shares of the real estate investment fund, determines a redemption cap based on a market condition mode and processes the received redemption orders according to the redemption cap. The cap may be, for example, a percentage of the shares available for redemption.

In another aspect a computer-implemented method for redeeming shares of an open-ended, unlisted real estate investment trust includes providing electronic access to an applications server on which computer-executable instructions are stored, that, when executed, facilitate the pricing and managed redemption of the real estate investment trust. The pricing and redemption of the fund includes calculating real estate pricing data based on a periodic appraisal of illiquid real estate assets held in the real estate investment trust and combining the real estate pricing data with pricing data related to liquid securities held by the real estate investment trust and accrued expenses, resulting in a fund net asset value.

In some embodiments, an adjustment may be applied to the real estate pricing data between periodic appraisals, and an adjusted net asset value of the unlisted real estate investment trust is calculated based on the real estate appraisal data and the pricing data related to liquid securities. A per share net asset value of the unlisted real estate investment trust may then be calculated based on the total net asset value and a number of outstanding shares.

In some cases, redemption orders are received and processed. In such instances, the redemption orders are received, a redemption cap (e.g., a percentage of shares available for redemption) is determined based on one of a plurality of market condition modes, and the redemption orders are processed according to the redemption cap. Moreover, in some embodiments, pre-redemption compliance testing may be incorporated to ensure compliance with certain federal income tax law restrictions regarding dividend equivalent redemptions.

### BRIEF DESCRIPTION OF DRAWINGS

In the drawings, like reference characters generally refer to the same elements throughout the different views. Also, the drawings are not necessarily to scale, emphasis instead generally being placed upon illustrating the principles of the invention.

FIG. 1 is an illustration of the environment in which various embodiments of the invention may be implemented.

FIG. 2 is a flowchart illustrating a process for calculating share values of a real estate investment trust according to various embodiments of the invention.

FIG. 3 is a flowchart illustrating a process for monitoring and managing share redemptions from a real estate investment trust according to various embodiments of the invention.

FIG. 4 is a schematic diagram of a system for implementing pricing and redemption processes for a real estate investment trust according to various embodiments of the invention.

### DETAILED DESCRIPTION

Daily transparent valuation of an investment provides a current and verifiable price for subscriptions and redemptions, and gives investment advisors and their clients the most up-to-date information available regarding the value of the fund. Typically, the current value of a “share” of an investment fund is calculated by summing up the net values of all the fund's holdings and dividing that result by the number of outstanding shares to arrive at a “net asset value per share,” “per share NAV” or simply an “NAV.” The per share NAV is then used as the price at which investors may buy into a fund, or, alternatively, the price at which they can redeem their shares. In conventional mutual funds, calculating an NAV is fairly straightforward when the funds comprise exchange-traded equities and traded bonds or other readily-priced assets. However, calculating an NAV for a fund that holds commercial real estate assets is much harder, as there is no “liquid” market for the assets.

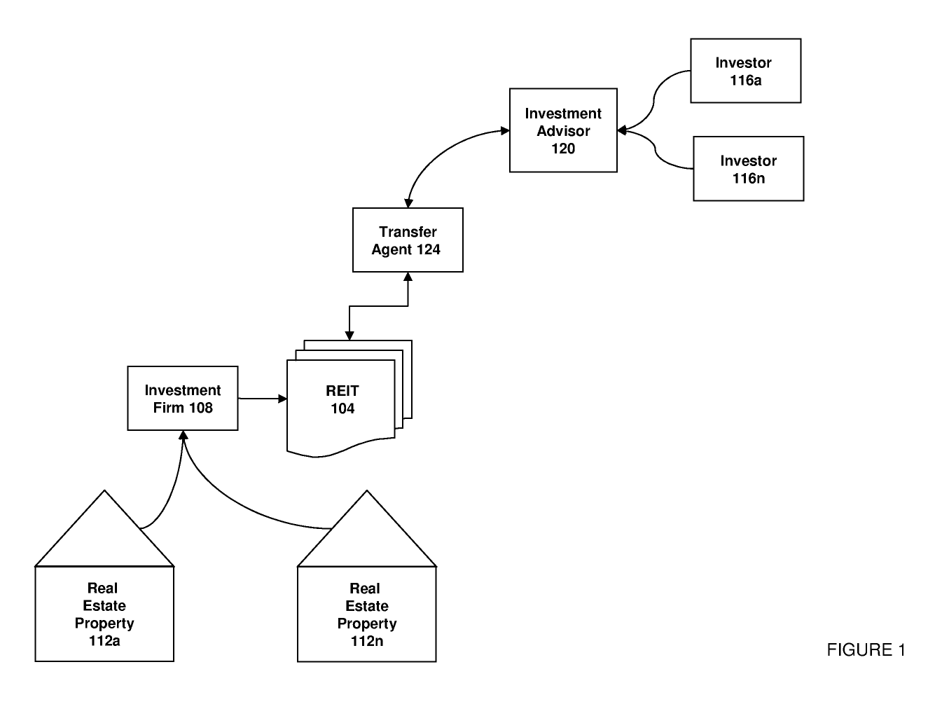

In general, and referring to FIG. 1, a REIT 104 is formed by an investment firm 108 based on its ownership or other legal interest in one or more physical properties 112a . . . 112n (generally, 112). The REIT is essentially a company or corporation that owns and in some cases operates income-producing real estate such as apartment complexes, commercial real estate properties and shopping malls. Investors 116a . . . 116n (generally 116) that would like to diversify their investment portfolio by including real estate based assets may invest in the REIT 104 by purchasing, usually through their investment advisor 112 and often a transfer agent 124. The shares may be held in an investment portfolio account, similar to equity shares of a company or a mutual fund. However, in some cases, the REIT shares are not traded on an open exchange, and therefore the market for the shares is “illiquid”—meaning there is not enough trading of the particular asset to determine a fair market value.

Some of the attributes of a REIT that use the techniques and systems described herein include being an open-ended, daily-dealing fund. The fund may or may not include a load fee, a performance fee, and/or a hurdle rate. The fund may accrue dividends on a periodic (e.g., daily) and pay distributions at the same periodicity or, in other cases, some other period (e.g., quarterly). The fund may have a minimum total raise (e.g., $10 million) and may initially only include marketable securities and cash until real estate properties are purchased or transferred into the fund.

Therefore, the techniques and systems described herein facilitate the daily calculation of a NAV for an open-ended, non-exchange traded REIT such that investment advisors and individual investors can purchase and redeem shares essentially at will and receive verifiable and transparent pricing when doing so. In general, the NAV calculation incorporates (1) regular rolling quarterly valuations of the real estate and certain real estate related investments by a valuation agent (who may, in some cases, be independent from the fund and its affiliates), (2) an ongoing valuation assessment of any events that require adjustments to the most recent quarterly valuation, (3) daily updates in the valuation of liquid assets, and (4) estimates of daily accruals for expenses and monthly distributions. Again, in some instances certain valuations and assessments may be performed by the fund managers, whereas in other cases certain valuation responsibilities may be taken on by independent valuation experts or pricing services.

Structurally, the NAV calculation comprises two asset groups—a Real Estate sleeve and the Liquid sleeve. The Real Estate sleeve includes all real properties owned by the fund and property-related financing. The Liquid sleeve includes all traded real estate-related and other securities and cash and cash equivalent instruments.

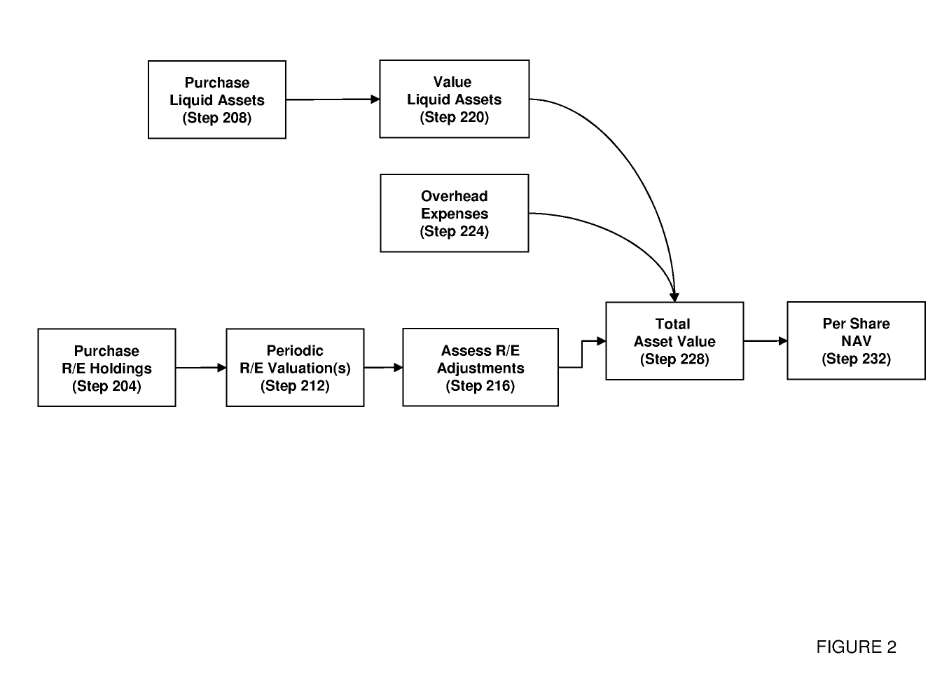

More specifically, and referring to FIG. 2, the REIT purchases assets from either class—Real Estate holdings (step 204) and may make additional purchases of liquid assets (equities, etc.) (step 208) to complete the asset holdings for the REIT.

At the time a property is purchased for the fund, a full valuation appraisal of the is property is obtained. The valuation may be obtained by using an independent third-party, or, in some cases, the REIT may employ appraisers for such tasks. Thereafter, on a quarterly basis after the first completed calendar quarter following the quarter of the purchase of the property, a periodic valuation update is completed (step 212). The periodic valuation update provides a basis for estimating the current fair market value of the holdings. The periodic valuation updates are conducted on a rolling basis, such as quarterly. In some instances, the current and interim valuation updates are reported throughout the month to maintain a relatively constant NAV attributable to the Real Estate sleeve. Interim adjustments may be implemented (step 216) if extraneous events occur or market conditions change dramatically.

A valuation expert may be engaged to provide the periodic estimates of the market value of the assets in the Real Estate sleeve, which often includes commercial real estate and notes receivable where the underlying collateral is commercial real estate owned by the fund. The valuation expert may be selected from any number of firms in the business of rendering opinions regarding the value of real estate assets and liabilities, and is provided with access to all information about investments in the Real Estate sleeve that the valuation expert may deem relevant. The estimates may be performed monthly, quarterly, semi-annually, annually, or virtually any periodicity that is logistically and financially practical. However, in most cases, valuations more frequent that quarterly may be over-burdensome and may not provide significant information to warrant the additional expense.

The valuation expert analyzes the cash flow from, and other characteristics of, each property in the Real Estate sleeve. Using a discounted cash flow approach to valuation (or other similar cash valuation techniques), the valuation expert analyzes projected cash flows of each property in the Real Estate sleeve to determine an estimate of the market value of each asset in the Real Estate sleeve. While a discounted cash flow approach is the principal methodology used in valuation of the Real Estate sleeve, the valuation expert may also consider, as appropriate, additional valuation methodologies, opinions and judgments, all of which are consistent with industry best practices.

Between quarterly valuations, the Real Estate sleeve is monitored to determine whether there have been any events that have a material impact on the most recent estimate of market value of real estate assets of the fund. If events that are likely to have a material impact on the NAV come to the attention of the valuation expert, the valuation expert prepares a For Cause Valuation Update by which adjustments are made to the estimated value of the affected asset(s) in the Real Estate sleeve (step 216) and are immediately reflected in the daily NAV. In certain instances, the monitoring may be done continuously, whereas in other cases it may be done periodically (e.g., every month, week and/or day).

On a quarterly basis the valuation expert also provides an estimate of the market value of notes receivable, primarily relying on a discounted cash flow analysis and an estimate of the market value of mortgages. Quarterly valuations are adjusted between quarters if deemed necessary by the valuation expert, and are immediately reflected in the daily NAV. As a result, the valuation expert is responsible for the estimated market value of the Real Estate sleeve on an ongoing basis.

Assets in the Liquid sleeve, which include traded real estate-related and other securities, cash and cash-equivalent instruments, are priced daily (step 220). The real estate-related and other securities are valued using current market prices that may be provided by independent pricing services, and the cash and cash equivalent instruments are valued using amortized cost. Overhead, fees, and other costs are captured and recorded against the appropriate fund as well (step 224).

The fund accounting agent (“Accounting Agent”) calculates the daily NAV after the close of business on each business day that the New York Stock Exchange is open (“Business Day”) by applying (a) the valuations provided by the valuation expert for the Real Estate sleeve, (b) the Liquid sleeve valuations as determined by independent pricing services and market quotes, and (c) the daily expense accruals of the fund, which principally include accrued distributions, advisory fees and other fund operating expenses (step 228).

The NAV then is determined by dividing the fund's net assets on each Business Day by the number of common shares outstanding as of the end of such day, prior to giving effect to any share purchases or redemptions to be effected on such day (step 232). This valuation process determines the purchase and redemption price per share (per share NAV), which may vary daily on each Business Day.

Any purchase orders received prior to 4:00 p.m. Eastern time on any Business Day are executed at a price equal to the NAV per share, as calculated after the close of business on that Business Day. Purchase orders received after 4:00 p.m. Eastern time on a Business Day are executed at a price equal to NAV per share as calculated after the close of business on the next Business Day. Purchase orders placed on a day that is not a Business Day are executed as if they were received prior to the close of business on the immediately following Business Day.

By this process, advisors (on behalf of their clients) and individual investors are able to purchase shares of common stock on any Business Day at an up-to-date NAV. There is no offering period of availability—the fund has perpetual life and is always available, on any business day, for new allocations.

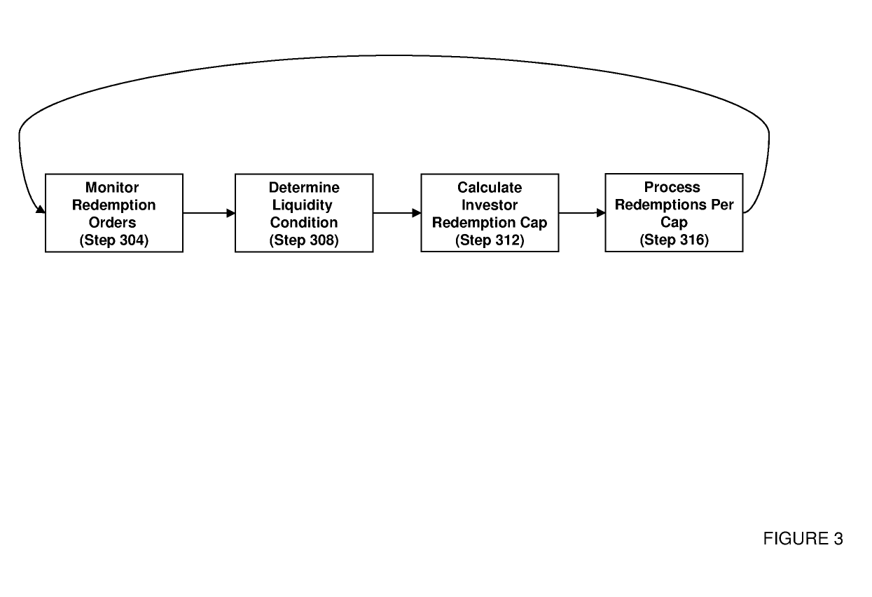

Referring to FIG. 3, the redemption process is designed to allow advisors to request redemptions on behalf of their clients (or by the investors directly) on a daily basis for all or any portion of their shares while considering current market conditions and the liquidity of the fund. In general, the redemption orders are monitored (step 304). At any one time, the fund operates in a particular “mode.” In one exemplary embodiment, the fund operates in either “Open—Normal” mode, “Stress” mode or “Emergency” mode. While the example below outlines three modes, additional modes may be defined based on particular market conditions and fund attributes. Based on the number and size of the redemption orders received, and the current market conditions, a liquidity condition of the fund is determined (step 308). If necessary, redemption caps are imposed upon individual investors based on liquidity conditions and for federal income tax law limits on dividend equivalent redemptions (step 312). The redemptions are then processed according to the caps (step 316). The process continues with a periodic reevaluation of the redemption orders and liquidity condition. To facilitate redemptions as requested, the fund expects to operate at all times with sufficient liquidity from the Liquid sleeve, a line of credit, and proceeds from daily share purchases to meet all redemption requests under normal market conditions. This is referred to as “Open—Normal Market Conditions.” However, exceptional conditions may warrant imposition of more stringent redemption limits.

For example, under Open—Normal Market Conditions, there may or may not be limitations on the amount of funds (either volume or dollar) that may be used for redemptions during any period (e.g., a calendar quarter or a rolling twelve month period). Limitations, if any, may be based on a specified and disclosed percentage of the fund's total net assets just prior to or at the beginning of a calendar quarter or a specified twelve-month period. The specified and disclosed percentage may take into account the level of redemption activity during prior periods. In such cases, all redemption requests are treated equally during a calendar quarter. Investment advisors and/or investors submit redemption requests at any time during the quarter, that is, whenever redemption proceeds may be required by the clients of the advisors or the clients themselves. In some implementations, there is no pro rationing of redemption proceeds, nor is there an order or priority in the treatment of redemption requests.

Only under unusual circumstances may there be further limits in redemption proceeds availability. Such circumstances may be caused by events beyond the control of the fund, such as an unexpected market or political event that results in several successive days of large redemptions. As a result of such unusual occurrences, liquidity may be exhausted in a predictable, brief time period such as two or more days of similar redemption activity. This is referred to as “Stress Conditions.” Under Stress Conditions, a “flow regulator” temporarily limits—but not necessarily curtails—redemptions until sufficient liquidity is attained. A flow regulator is expressed as a percentage, and ranges from 1% to 99% under Stress Conditions. The flow regulator percentage may be applied equally to all investor accounts. The flow regulated percentage may be applied for a brief period, or the remainder of a calendar period (e.g., the rest of the calendar quarter).

In implementation, the flow regulator percentage determines the maximum number of shares eligible to be redeemed by an investor (the “Cap”), and is set initially on the day the flow regulator percentage is implemented. The flow regulator percentage is expressed as a percent of the ending share balance in the investor's account on the day the flow regulator percentage is implemented. On the next Business Day (“T+1”), the flow regulator percentage becomes effective, and is applicable to all redemption requests received beginning on T+1. Advisors and other interested parties are notified of the flow regulated percentage on T+1 (and any subsequent adjustments). These communications enable advisors to more predictably forecast redemption proceeds that their clients may be able to receive during the remainder of the calendar quarter.

The flow regulator percentage structure encourages advisors to continue allocating monies to the fund. In some cases, purchases made after the Cap is set during the period between the initiation of a Stress Condition through the end of the quarter (when a change in the flow regulated percentage may next be effected), may be exempt from the Cap and therefore are eligible for redemption during that quarter. To the extent necessary, the Cap may reset quarterly based on an investor's holdings as of the last Business Day of each quarter, or whenever there are changes in the flow regulated percentage—either up or down; or the Cap may remain in effect during subsequent quarters until redemption activity subsides to certain specified and disclosed levels. When a flow regulated percentage is implemented during a quarter, the flow regulated percentage is typically not be adjusted (up or down) prior to the end of that calendar quarter.

In a typical asset allocation strategy, an investment advisor or individual investor may look for liquidity sources from the investment portfolio. The flow regulated percentage provides predictability to the advisor because they are able to accurately forecast the redemption proceeds that are able to be garnered from an investment in the fund during the remainder of the calendar quarter, even under Stress Conditions. The Fund continues to operate in this flow regulated percentage mode until a return to Open—Normal Market Conditions, or until Emergency Conditions are invoked.

While Emergency Conditions are not expected to occur with any frequency, they may arise as a result of extreme events (e.g., war, hurricane, earthquake, etc.) that are beyond the control of the fund. If invoked, Emergency Conditions are intended to be temporary. As with Normal and Stress Conditions, all investors are always treated equally. The mechanics during a Business Day under an Emergency Condition follow one of two possible scenarios.

On the Business Day that the Emergency Condition is invoked, all redemption requests for that Business Day are pro-rated based on available liquidity and the aggregate amount of redemption requests. The pro-rated percentage is applied to each redemption request as a percentage of the aggregate redemption request, and not as a percentage of the shareholder's account. Thus, on a Business Day when Emergency Conditions are implemented, all shareholders receive the same pro-rated percentage of their redemption request made on that Business Day. Alternatively, all redemption requests may be rejected for that Business Day, and each investor's Cap reset to 0%. Regardless of the option employed, each investor's Cap then is set at a flow regulated percentage of 0%. When the flow regulated percentage is at 0%, redemptions are suspended until the Fund is able to open under Open—Normal Market Conditions or Stress Conditions. At that point redemption requests again will be honored under the provisions of Open—Normal Market Conditions or Stress Conditions.

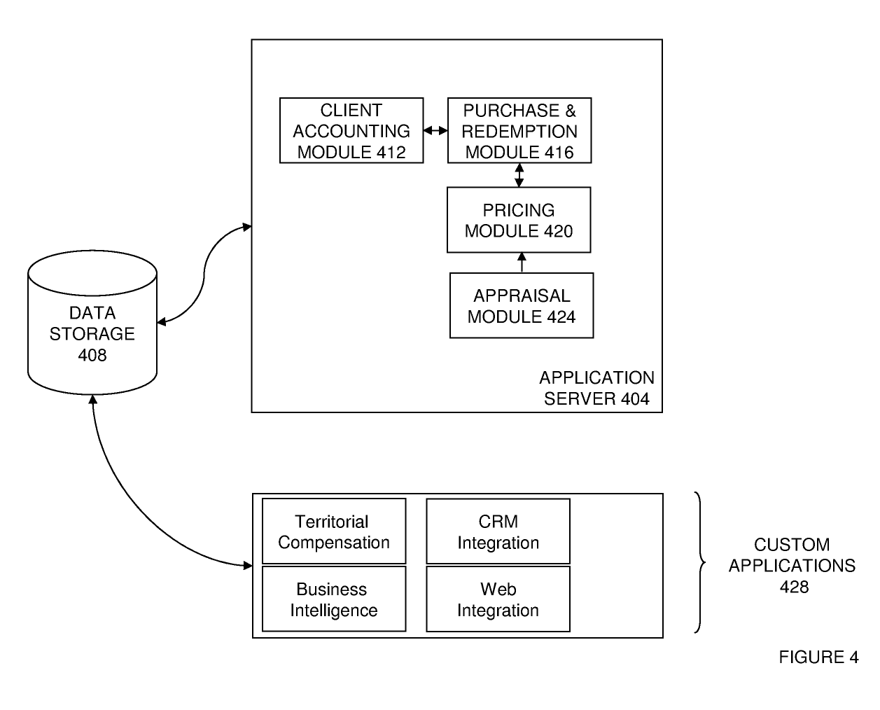

Referring to FIG. 4, the techniques described above may be implemented on one or more hardware devices comprising sufficient memory and processing resources. For example, the client accounting, appraisal, pricing and NAV calculations and purchase and redemption processes may each be implemented as functional modules being executed on one or more servers 404. An exemplary server comprises hardware CPU(s), operatively connected to hardware/physical memory and input/output (UO) interface. Hardware/physical memory may include volatile and/or non-volatile memory. The memory may store one or more instructions to program the CPU to perform any of the functions described herein. The memory may also store one or more application programs. Separate data storage server(s) may also be used to store client information, investment portfolio information and account information 408.

The processes and functions may be allocated to one or more computational modules that are implemented as computer-executable instructions on the server 404. For example, a client accounting module 412 may be used to manage the funds associated with each individual investor and invested in any particular investment vehicle. The purchase and redemption processes may be implemented by a purchase and redemption module 416, which determines any stress conditions, imposes caps, and executes purchase and redemption orders, in addition to other transactions. A pricing module 420 determines the total value for the fund (or funds) based on the values of the underlying assets and the NAV based on the number of outstanding shares. The system may also include an appraisal module 424 to facilitate the calculation and storage of appraisal information regarding the underlying real estate assets.

Although examples provided herein may have described the modules as residing on a single server, it should be appreciated that the functionality of these components can be implemented on any larger number of computers in a distributed fashion. Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

One skilled in the art will realize the invention may be embodied in other specific forms without departing from the spirit or essential characteristics thereof. The foregoing embodiments, together with the attached exhibits, are therefore to be considered in all respects illustrative rather than limiting of the invention described herein.

For further description of illustrative embodiments along with further details and applications of the invention, refer to the following documents, behind the indicated tabbed dividers. It should be noted that all headings are only illustrative in nature and are not to be construed in any limiting sense.

What is claimed is:

1. A system for pricing shares of an open-ended, unlisted real estate investment trust, the system comprising:
a processor for executing computer-executable instructions;
a memory for storing computer executable instructions, that when executed by the processor implements (i) an appraisal module that facilitates the determination of real estate pricing data based on a periodic appraisal of illiquid real estate assets held in the real estate investment trust; and (ii) a pricing module that combines the real estate pricing data with pricing data related to liquid securities held by the real estate investment trust, resulting in a fund net asset value.

2. The system of claim 1 wherein the appraisal module further facilitates the application of an adjustment to the real estate pricing data between periodic appraisals.

3. The system of claim 2 wherein the pricing module further calculates an adjusted net asset value of the unlisted real estate investment trust based on the real estate appraisal data, the adjustment, pricing data related to liquid securities, and estimates of daily accruals for periodic expenses and distributions.

4. The system of claim 2 wherein the pricing module further calculates a per share net asset value of the unlisted real estate investment trust based on the adjusted net asset value and a number of outstanding shares.

5. The system of claim 1 further comprising a data storage module for storing the real estate appraisal data and pricing data related to liquid securities.

6. The system of claim 1 further comprising a redemption module that (i) receives redemption orders from owners of shares of the real estate investment fund; (ii) determines a redemption cap based on one of a plurality of market condition modes; and (iii) processes the received redemption orders according to the redemption cap.

7. The system of claim 6 wherein the redemption cap comprises a percentage of shares available for redemption.

8. A computer-implemented method for redeeming shares of an open-ended, unlisted real estate investment trust, the method comprising:
providing electronic access to an applications server on which computer-executable instructions are stored, that, when executed, facilitate the pricing and managed redemption of the real estate investment trust, wherein the pricing and redemption of the fund comprises:
(i) calculating real estate pricing data based on a periodic appraisal of illiquid real estate assets held in the real estate investment trust; and
(ii) combining the real estate pricing data with pricing data related to liquid securities held by the real estate investment trust, resulting in a fund net asset value.

9. The method of claim 8 further comprising applying an adjustment to the real estate pricing data between periodic appraisals.

10. The method of claim 9 further comprising calculating a adjusted net asset value of the unlisted real estate investment trust based on the real estate appraisal data, the adjustment, pricing data related to liquid securities, and estimates of daily accruals for periodic expenses and distributions.

11. The method of claim 8 further comprising calculating a per share net asset value of the unlisted real estate investment trust based on the adjusted net asset value and a number of outstanding shares.

12. The method of claim 8 further comprising
(iii) receiving redemption orders from owners of shares of the real estate investment fund;
(iv) determining a redemption cap based on one of a plurality of market condition modes; and
(v) processing the received redemption orders according to the redemption cap.

13. The method of claim 12 wherein the redemption cap comprises a percentage of shares available for redemption.
